(19) United States
(12) Patent Application Publication
(10) Pub. No.: US 2007/0237034 A1
(43) Pub. Date: Oct. 11, 2007

(54) Method for forming a timepiece train wheel support plate and a timepiece comprising a mold structure for forming a timepiece train wheel support plate and a timepiece train wheel support plate formed of the same

(76) Inventors: Tamotsu Ono, Chiba-shi (JP); Yuichi Shino, Chiba-shi (JP)

Correspondence Address: BRUCE L. ADAMS, ESQ., SUITE 1231, 17 BATTERY PLACE, NEW YORK, NY, 10004, US

(21) Appl. No.: 11/488,567

(22) Filed: Jul. 18, 2006

(30) Foreign Application Priority Data
Aug. 8, 2005 (JP) 2005-229063

(51) Int. Cl. G04B 1/00

(52) U.S. Cl. 368/139

(57) ABSTRACT

To provide a method for forming a timepiece train wheel support plate, which allow the formation of a horizontal hole without using a hydraulic core, and molds for forming a timepiece train wheel support plate, as well as timepiece train wheel support plate formed by the molds and a timepiece having the timepiece train wheel support plate. A method for forming a bottom board involves moving a pair of molds having a plurality of protrusions closer to an opposite surface, fitting end portions of the plurality of protrusions on one mold of the pair of molds among end portions of a plurality of protrusions on the other mold, and filling void spaces formed by the pair of molds with molding material to form a timepiece train wheel support plate having a horizontal hole corresponding to a series of the end portions of the plurality of protrusions on the pair of molds, the series of the end portions being fit to one another.

### BACKGROUND OF THE INVENTION

1. Field of the Invention

The present invention relates to a method for forming a timepiece train wheel support plate like a bottom board having a hole (horizontal hole) extending in a direction in which the plate extends, a mold structure for forming a timepiece train wheel support plat, a timepiece train wheel support plate formed of the same and a timepiece having the support plate.

2. Description of the Prior Art

A wrist watch having a bottom board including a hole through which a winding stem is inserted in the form of a hole portion open on a perimeter (side surface) and extending from the opening in a direction in which the bottom board extends is well known (for example, Patent Documents 1 and 2 and the like).

The core and bottom board of this type of a conventional wristwatch has a configuration as shown in FIG. 5, for example. In other words, as partially shown in a cross-sectional view of FIG. 5, a wristwatch 101 has a bottom board 110 that working with a train wheel bridge 102 to support a time train wheel 103 inside an external case (not shown). The bottom board 110 includes a winding stem insertion aperture 120 in which a winding stem 130 is attached. In this example, the winding stem insertion aperture 120 is a through hole since a minute wheel is directly engaged with a clutch wheel. However, as shown in Patent Documents 1 and 2, a void space for a winding stem insertion may take the form of a bottomed hole with a wall deep in the end.

The winding stem 130 has an intermediate-diameter rectangular column portion 131, a large-diameter cylindrical portion 132, an intermediate-diameter abacus-bead-shaped portion 133, and a large-diameter shaft portion 134 on the base end portion. The winding stem 130 also has a small-diameter connecting shaft portion 137 between the rectangular column portion 131 and the large-diameter cylindrical portion 132. The winding stem 130 also has small-diameter portions 136a and 136b on both sides of the abacus-bead-shaped portion 133. The shaft portion 134 on the base end portion has a locking jaw portion 138 in the middle. The shaft portion 134 also includes a shaft portion 134a located deeper than the locking jaw portion 138 and a shaft portion 134b for mounting a crown, located more external (on the base end portion side) than the locking jaw portion 138.

The winding stem insertion aperture 120 has large-diameter cylindrical hole portions 121 and 122 on the entry side, through which the jaw portion 138 of the shaft portion 134 on the base end portion side and deeper shaft portion 134a of the winding stem 130 can slide in the X1 or X2 direction and go out or come in. The winding stem insertion aperture 120 has a deeper large-diameter cylindrical hole portion 123, through which the large-diameter cylindrical portion 132 can slide in the X1 and X2 directions. The large-diameter cylindrical hole portions 121 on the entry side is open on one side 111a of the external surface 111 of the bottom board 110. A cylindrical hole portions 123 located deeper is open on a deeper side surface 112a of the wall 112 of the bottom board 110. Note that the bottom board 110 has a recess 113 for housing a clutch wheel in a position along the deeper side surface 112a of the wall 112, which recess extends from the front side of the bottom board 110 to the back side in a thickness direction Z. The bottom of the recess 113 for housing a clutch wheel is nearly semi-cylindrical (the cross section is nearly semicircular). The bottom board 110 also has a wall 114 behind the recess 113 for housing a clutch wheel, from which the rectangular column portion 131 located at the tip of the winding stem 130 can protrude in the X2 direction along a surface 114a. The bottom board 110 also has a spring housing hole portion 115 that extends in a thickness direction Z at small-diameter portions 136a and 136b on both sides of the abacus-bead-shaped portion 133 of the winding stem 130.

A clutch wheel 150 is arranged in the recess 113 for housing a clutch wheel. The clutch wheel 150 has an intermediate-diameter rectangular column portion 151 with a cross-section shape complementary to the rectangular column portion 131 of the winding stem 130. The clutch wheel 150 also has a intermediate-diameter cylindrical hole portions 152, which is located on the tip side of the cylindrical hole portions 151 and shaped to circumscribe the rectangular column portion 131. In addition, the clutch wheel 150 has a large-diameter cylindrical hole portions 153 on the base end portion side and a gear portion 154 located deeper. When the winding stem 130 is set in a hand-turning position drawn out in the X1 direction as shown in FIG. 5, the cylindrical hole portions 151 of the clutch wheel 150 is just fit into the rectangular column portion 131 of the winding stem 130. The clutch wheel 150 then turns in response to the turning of the winding stem 130 around the central axis A. Meanwhile, if the winding stem 130 is pushed in the X2 direction into a usual hand-moving position, the cylindrical hole portions 151 of the clutch wheel 150 is loosely fit into the small-diameter shaft portion 137. The cylindrical hole portions 152 then circumscribes the rectangular column portion 131 of the winding stem 130, thus fitting the clutch wheel 150 into the winding stem 130. The clutch wheel 150 is therefore rotatable around the central axis A with respect to the winding stem 130.

The gear portion 154 of the clutch wheel 150 is engaged with a gear portion 163 of a minute wheel 160 rotatably supported by shaft portion 161 and 162 through the bearing portion 114b of the wall 114 of the bottom board 110 and the bearing portion 102a of the train wheel bridge 102. The gear portion 163 of the minute wheel 160 is engaged with a cannon pinion portion of a minute wheel not shown. A cannon pinion portion 164 protruding in the Z2 direction to the back side of the bottom board 110 is engaged with the gear portion of a cylindrical wheel (hour wheel) not shown.

A spring portion 166, which constitutes part of an positive battery terminal 165 supported by the train wheel bridge 102, is engaged with the small-diameter portion 136b or 136a of the winding stem 130 at an opening 168 in a bent end portion 167. When the winding stem 130 is moved in and out in the X1 and X2 directions, the spring portion 166 permits the winding stem 130 to move in and out in the X1 and X2 directions while elastically pressing the abacus-bead-shaped portion 133 and the spring portion 166 is elastically fit into the other small-diameter portion 136a or 136b. In this way, a feel of click is produced and the winding stem 130 is held in a stable way in the position of interest. Note that a reference numeral 169 is a cylindrical-wheel retainer.

As described above, in an electronic timepiece 101, the bottom board 110 as a train wheel supporting plate is composed of a roughly tabular body and extends along a single plane (X-Y plane, in this case). The winding stem 130 extends from the outer peripheral portion 111a of the bottom board 110 to the central portion in a direction along the plane in which the bottom board 110 extends. Under this condition, it is essential that with the winding stem 130 supported by the bottom board 110, the winding stem 130 should be directly or indirectly engaged with timepiece components 150, 160, 165 and the like such as train wheels supported directly or indirectly by the bottom board 110. Therefore, in a conventional electronic timepiece 101, an insertion aperture (or a hole) 120 for an the winding stem 130 is always provided along the intermediate portion of the bottom board 110 in the thickness direction Z from the outer peripheral portion 111a of the bottom board 110 to the central portion of the bottom board 110, although there is some difference depending on the types and arrangement of timepiece parts required.

To form the bottom board 110 having a winding stem insertion aperture 120 described above through molding, a pair of molds placed closer to or away from each other in the direction of the front and back of the bottom board 11 is essential. It is also essential that an elongated pin-shaped hydraulic core or slide core should be used, which is inserted in a direction at a right angle to the thickness direction. It is difficult to avoid a complicated configuration and higher molding costs as a whole. Particularly in small and precise machines such as wristwatches, hydraulic cores and/or slide cores are inevitably narrow (for example, 1 mm or so wide) and require handling precautions as well.

The inventor earnestly studied and developed means for minimizing molding costs of bottom boards as described above.

As a result, the inventor has determined that a train wheel support plate like a bottom board can be formed without using a hydraulic or slide core.

<Patent Document 1> JP-UM-A-1-44492 (Microfilm)

<Patent Document 2> Specification for Japanese Utility Model No. 2596992

The present invention considers the points described above. An object of the investigation is to provide a method for forming a timepiece train wheel support plate, which allows a horizontal hole to be formed without using a hydraulic core, a mold for forming a timepiece train wheel support plate, a timepiece train wheel support plate formed by the mold, and a timepiece having the timepiece train wheel support plate.

### SUMMARY OF THE INVENTION

To achieve the aforementioned object, a method for forming a timepiece train wheel support plate according to the present invention comprises the steps of moving a pair of molds having a plurality of protrusions closer to an opposite surface fitting end portions of the plurality of protrusions on one of the pair of molds among end portions of a plurality of protrusions on the other mold and filling a void space formed by the pair of molds with molding material to form a timepiece train wheel support plate having a horizontal hole corresponding to a series of the end portions of the plurality of protrusions on the pair of molds, the series of the end portions being fit to one another.

In the method for forming a timepiece train wheel support plate according to the investigation, a horizontal hole can be formed by means of a series of end portions fit into a plurality of protrusions on a pair of molds. This eliminates the need for a hydraulic core for the formation of the horizontal hole. In other words, in the method for forming a timepiece train wheel support plate according to the investigation, a timepiece train wheel support plate having a horizontal hole can be formed by simply moving a pair of mold closer to or away from each other. Therefore, a timepiece train wheel support plate can be formed easily. Besides, the number of molds can be minimized and molds having amore complicated configuration can be avoided. Therefore, costs required for molds and for forming timepiece train wheel support plates can also be minimized.

Note that a train wheel bridge or other receiving materials may be used as a timepiece train wheel support plate instead of a typical bottom board. A horizontal hole is typically a through hole in the winding stem. In some cases, however, the horizontal hole may be a hole into which other rod- or pin-shaped bodies will be inserted. The horizontal hole may be a bottomed hole (blind hole) with the bottom closed or a through hole with the bottom open. In addition, the horizontal hole typically extends in a right-angle direction in the thickness direction of the timepiece train wheel support plate. In some cases, however, the horizontal hole may be inclined slightly. Note that the horizontal hole typically has a plurality of portions each having a different size of a cross section. The horizontal hole may, if desired, have the same size and shape of a whole cross section in the longitudinal direction. The horizontal hole typically has a wall surface that circumscribes a pin-shaped body inserted into the horizontal hole, in which case, the horizontal hole may have a quadrangular such as rectangular, polygonal, circular, or elliptical cross section.

To attain the aforementioned object, a mold structure for forming a timepiece train wheel support plate according to the investigation comprises first and second molds relatively movable between a mold-clamping position and a mold-separating position, the first mold comprising a plurality of protrusions having an end portion extending parallel from a surface facing the second mold toward the second mold and the second mold comprising a plurality of protrusions having an end portion extending parallel from a surface facing the first mold toward the first mold and, when set in the mold-clamping position, fit among end portions of adjacent protrusions of the plurality of protrusions on the first mold, characterized in that in the mold-clamping position, the end portions of the plurality of protrusions of the first and second molds, being fit to one another, defines a shaft-like void space formation portion extending continuously in a direction intersectional to a direction in which the end portions extend.

The mold structure for forming a timepiece train wheel support plate according to the investigation comprises first and second molds relatively movable between a mold-clamping position and a mold-separating position, and in the mold-clamping position, the end portions of the plurality of protrusions of the first and second molds, being fit to one another, defines a shaft-like void space formation portion extending continuously in a direction intersectional to a direction in which the end portions extend. This eliminates the need for a horizontal core otherwise used to forming a shaft-shaped void space (i.e., a horizontal hole) extending continuously in a direction intersectional to a direction in which the end portions extend, which are formed by a shaft-like void space formation portion. In other words, in the mold structure for forming a timepiece train wheel support plate according to the investigation, a timepiece train wheel support plate having a shaft-shaped void space (a horizontal hole) can be formed by simply moving a pair of molds relatively between the mold-clamping position and the mold-separating position.

Therefore, a timepiece train wheel support plate can be formed easily. Besides, the number of molds can be minimized and molds having a more complicated configuration can be avoided. Therefore, costs required for molds can also be minimized.

In the mold structure for forming a timepiece train wheel support plate according to the invention, the first mold comprises a plurality of protrusions having an end portion extending parallel from a surface facing the second mold toward the second mold. The second mold comprises a plurality of protrusions having an end extending parallel from a surface facing the first mold toward the first mold and, when set in the mold-clamping position, fit among end portions of adjacent protrusions of the plurality of protrusions on the first mold. Therefore, in the mold-clamping position, a protrusion forming surface (a recess or the bottom of the void space) of each of the first and second molds and avoid space in the mold structure formed between the base end portion of an adjacent protrusion in the mold and the end surface of a protrusion on the other mold provide a wall (part of a peripheral wall) defining a shaft-shaped void space.

The configuration and shape of the timepiece train wheel support plate and the shaft-shaped void space (horizontal hole) thereof are as described in the description of a method for forming a timepiece train wheel support plate.

In the mold structure for forming a timepiece train wheel support plate according to the present invention, at least one of the plurality of protrusions on one of the first and second molds typically has a different height from a height of the other protrusions. In the above case, a shaft-shaped void spaces of different sizes can be formed depending on longitudinal portions. However, all of these shaft-shaped void spaces may have the same height. Of the plurality of protrusions on the other mold, at least one protrusion may also have a height different from those of other protrusions.

In the mold structure for forming a timepiece train wheel support plate according to the present invention, of the plurality of protrusions on one of the first and second molds, the surface of a recess between at least a set of adjacent protrusions typically has a different height from a height of the surface of a recess between other sets of adjacent protrusions. In the above case, timepiece train wheel support plates having different geometries can be formed depending on longitudinal portions of the shaft-shaped void spaces. However, all of these timepiece train wheel support plates may have the same height. Note that of the plurality of protrusions on the other mold, the surface of a recess between at least a set of adjacent protrusions has a different height from a height of the surface of a recess between other sets of adjacent protrusions.

In the mold structure for forming a timepiece train wheel support plate according to the present invention, of the plurality of protrusions on one of the first and second molds, the surface of a recess between at least a set of adjacent protrusions has a surface portion with a different height. In this case, timepiece train wheel support plates having different geometries can also be formed depending on longitudinal portions of the shaft-shaped void spaces. However, all surfaces of a recess may be located on one plane. It can be considered that of the plurality of protrusions on-one of the first and second molds, at least one protrusion has a surface portion with a different height in stead of that a recess has a surface portion with a different height. In this case, of the plurality of protrusions on the other mold, the surface of a recess between at least a set of adjacent protrusions may also have a surface portion with a different height.

In the mold structure for forming a timepiece train wheel support plate according to the present invention, one of the first and second molds may have a small protrusion that comes into contact with the middle of a end face of an end portion of one of the plurality of protrusions on the other mold.

In the above case, the position for clamping the first and second molds can be defined accurately with the contact. Besides, a wall extending in one lateral direction can be formed as a wall (portion of a peripheral wall) for defining a shaft-shaped void space.

Note that the other mold may also have a small protrusion that comes into contact with the middle of a end face of an end portion of one of the plurality of protrusions on other mold.

In the mold structure for forming a timepiece train wheel support plate according to the present invention, the protrusions of the first and second molds typically extend substantially vertical to a train wheel support plate that should be formed. In other words, the side surface of the protrusion typically extends parallel to a direction in which a pair of molds are moved closer to and away from each other. The base end portion may have part or all of a portion that will be narrower closer to the tip portion, if desired. Note that a pair of molds may be moved closer to and away from each other through a turning around one axis, if desired, although typically a pair of molds are linearly moved closer to and away from each other. In the above case, every protrusion has a concentric cylindrical surface.

To attain the aforementioned object, the timepiece train wheel support plate according to the present invention is a timepiece train wheel support plate open on a side thereof and having a slotted hole extending in a direction in which the plate extends from the side; said plate characterized by comprising, a first set of a plurality of hole provision walls spaced in a longitudinal direction of the hole on one side in a thickness direction of the plate to define the slotted hole, and a second set of a plurality of hole provision walls spaced in a longitudinal direction of the hole on the other side of the plate on the other side in a thickness direction of the hole, characterized in that on the one side in the thickness direction of the plate, portions facing the second set of individual hole provision walls in a thickness direction are a first gap between the first set of hole provision walls, and characterized in that on the other side in the thickness direction of the plate, portions facing the first set of individual hole provision walls in a thickness' direction are a second gap between the second set of hole provision walls.

In the timepiece train wheel support plate according to the invention, hole provision walls for defining a slotted hole extending in a direction in which the timepiece train wheel support plate are provided not on both sides of the hole but one side as viewed in the thickness direction of the plate. Therefore, a timepiece train wheel support plate having the hole can be formed by means of a pair of molds that are moved closer to and away from each other in the thickness direction.

In the timepiece train wheel support plate according to the invention, typically, on the one side in the thickness direction of the plate, portions facing the second sets with respect to at least a portion of intervals are gaps between the first set of hole provision walls. In the above case, a recess or gap can be formed, which is intersectional to the slotted hole in the thickness direction. Needless to say, it may be considered that on the other side in the thickness direction of the plate, portions facing the first sets with respect to at least a portion of intervals are gaps between the second set of hole provision walls.

In the timepiece train wheel support plate according to the invention, on the one side in the thickness direction of the plate, portions facing the second sets with respect to the gaps between the second set of hole provision walls are gaps between the first set of hole provision walls, if desired. On the other side in the thickness direction of the plate, portions facing the second sets with respect to the gaps between the second set of hole provision walls are the second set of hole provision walls.

In the above case, a timepiece part such as a winding stem that is inserted through and extending through the hole can be held by the hole provision wall on any side in the thickness direction.

A timepiece train wheel support plate as described above is typically used in a small timepiece such as a wristwatch. The timepiece may be an electronic timepiece that is driven by a battery and a quartz-crystal oscillator or a mechanical timepiece.

### BRIEF DESCRIPTION OF THE SEVERAL VIEWS OF THE DRAWINGS

A preferred form of the present invention is illustrated in the accompanying drawings in which:

FIG. 1A is an explanatory diagram of part of a mold structure and an electronic timepiece according to a preferred embodiment of the present invention;

FIG. 1B is a cross-sectional diagram partially showing the winding stem in a usual hand-moving position in terms of an electronic timepiece having a bottom board 10 formed using the mold structure shown in FIG. 1A (The cross section of the bottom board is in a position corresponding to the cross section of the mold structure);

FIG. 2 is a perspective explanatory diagram showing part of the bottom board of FIG. 1B formed using the mold structure of FIG. 1A;

FIG. 3 is a cross-sectional explanatory diagram similar to FIG. 1B concerning a winding stem in a hand-turning position in terms of the electronic timepiece of FIG. 1B;

FIG. 4 is a cross-sectional explanatory diagram similar to FIG. 3 for showing a difference between the bottom board 10 of the electronic timepiece of FIG. 3 and the bottom board 10 of the electronic timepiece of FIG. 5 in shape (construction) with the winding stem in a hand-turning position; and

FIG. 5 is a cross-sectional diagram similar to FIG. 3 concerning the winding stem in a hand-turning position in terms of a conventional electronic timepiece.

### DETAILED DESCRIPTION OF THE PREFERRED EMBODIMENTS

An preferred embodiment of the present invention will described below with reference to the accompanied drawings.

Before the description of a method for forming a bottom board as a method for forming a timepiece train wheel support plate according to a preferred embodiment of the present invention and mold structure for forming a time piece train wheel support plate, a bottom board as a timepiece train wheel support plate according to a preferred embodiment of the invention and an electronic timepiece having the same will be described, which has a configuration suitable for formation by the method and the mold structure.

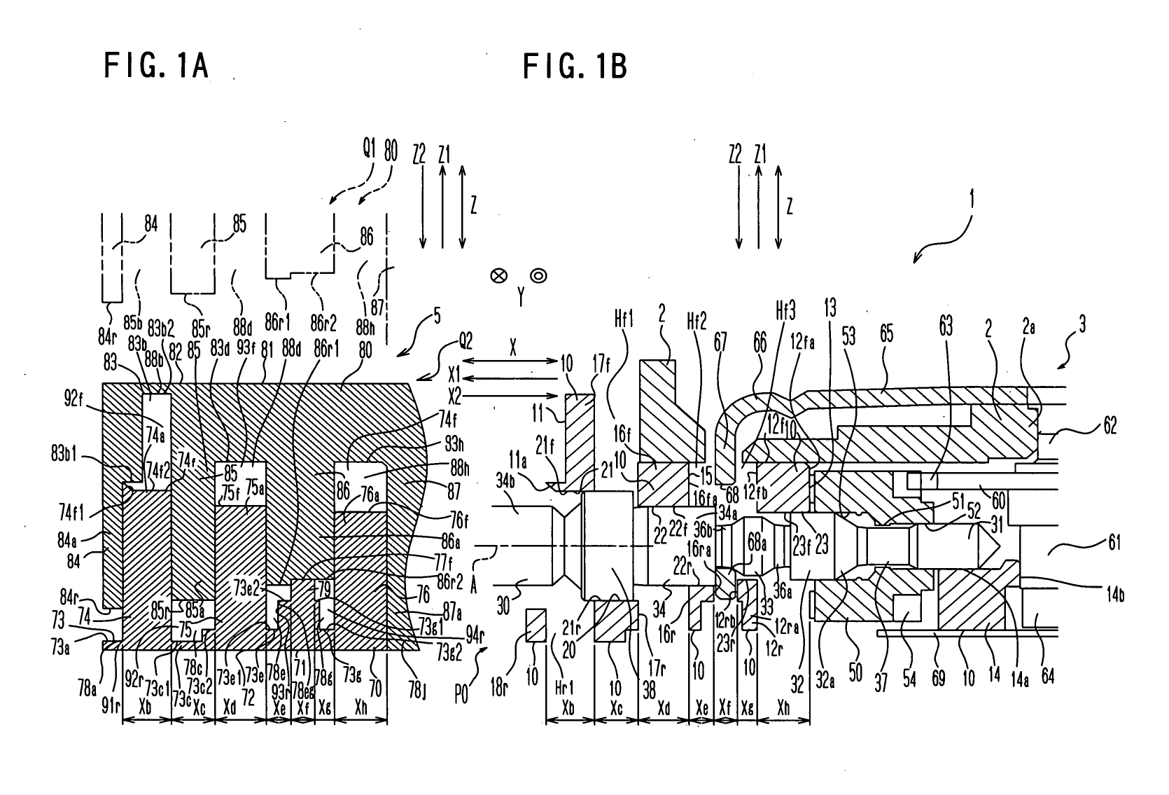

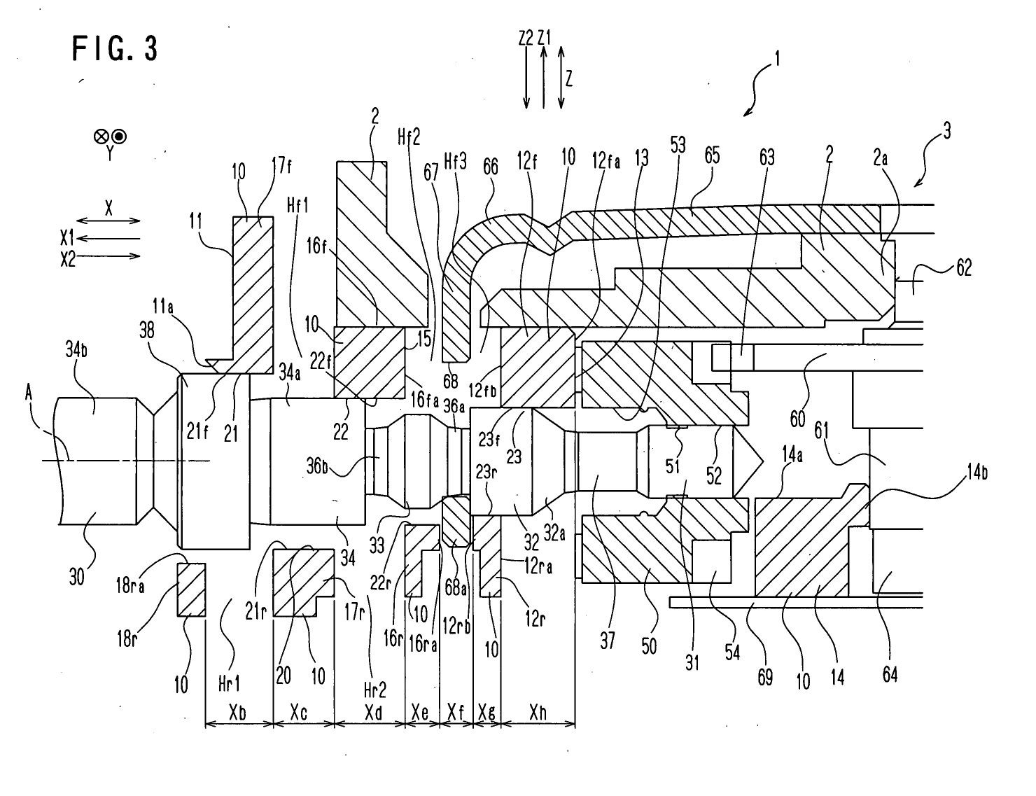

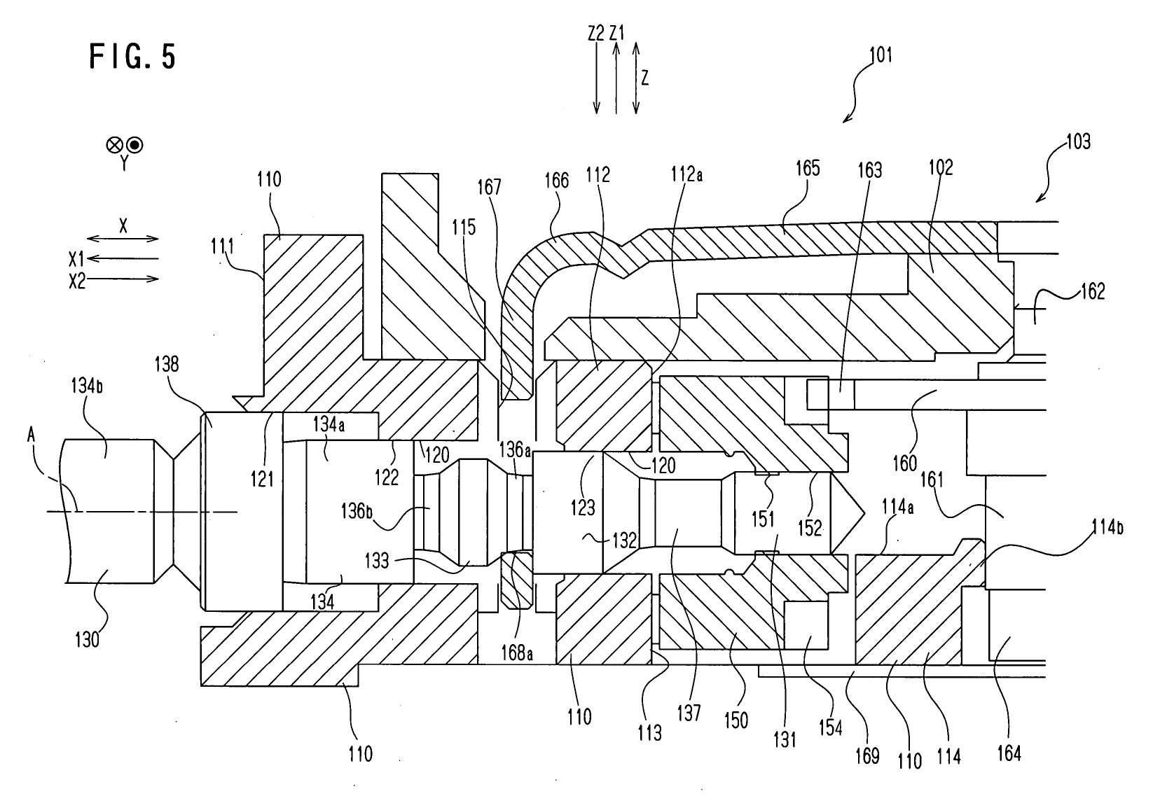

FIGS. 1B and 3 show portions of an electronic timepiece 1 having a bottom board 10 as a timepiece train wheel support plate according to a preferred embodiment of the present invention. The electronic timepiece 1 has the same configuration as the conventional electronic timepiece 101 shown in FIG. 5, except that there is a difference in construction or shape between bottom board 10 and a bottom board 110.

In other words, as partially shown in the cross-sectional view of FIG. 1B, the electronic timepiece 1 in the form of a wristwatch has a bottom board 10 that cooperates with a train wheel bridge 2 and the like to support a timepiece train wheel 3 inside an external case (not shown). The bottom board 10 has a winding stem insertion aperture 20 in which a winding stem 30 is attached.

The winding stem 30, like the winding stem 130, has an intermediate-diameter rectangular column portion 31, a large-diameter cylindrical portion 32, an intermediate-diameter abacus-bead-shaped portion 33, and a large-diameter shaft portion 34 on the base end portion. The winding stem 30 also has a small-diameter connecting shaft portion 37 between the rectangular column portion 31 and the large-diameter cylindrical portion 32. The winding stem 30 also has small-diameter portions 36a and 36b on both sides of the abacus-bead-shaped portion 33. The shaft portion 34 on the base end portion has a locking jaw portion 38 in the middle. The shaft portion 34 also includes a shaft portion 34a located deeper than the locking jaw portion 38 and a shaft portion 34b for mounting a crown, located more external (on the base-end portion side) than the locking jaw portion 38. In this example, the large-diameter shaft portion 34 has a larger diameter than a large-diameter cylindrical portion 32. However, the shaft portion 34 has the same diameter as the large-diameter cylindrical portion 32. The abacus-bead-shaped portion 33 may have the same diameter as at least one of the shaft portion 34 and the cylindrical portion 32. The small-diameter connecting shaft portion 37 may not be provided if the frustum-shaped portion 32a, for example, is provided behind the large-diameter cylindrical portion 32.

The winding stem insertion aperture 20 extending in the X direction is in the form of a hole as viewed in the X2 direction from an opening 11a in the hole 20 in an outside surface 11 of the bottom board 10. As described below in detail, however, a type of a peripheral wall that entirely surrounds the entire periphery of the hole 20 does not exist and part of the peripheral wall is always missing in any position in the X direction if the hole is viewed in the cross section vertical to the X direction.

The winding stem insertion aperture 20 has a kind of hole-shaped portion 21 defined by peripheral surface portions 21f, 21r on the front and back sides on the entry side, through which the jaw portion 38 of the large-diameter shaft portion 34 on the base end portion side of the winding stem 30 can slide in the X1 or X2 direction and go out or come in. The winding stem insertion aperture 20 also has a kind of hole-shaped portion 22 defined by peripheral surface portions 22f, 22r on the front and back sides on the intermediate side, through which the deeper shaft portion 34a of the large-diameter shaft portion 34 on the base end portion side can slide in the X1 or X2 direction and go out or come in. The winding stem insertion aperture 20 also has a kind of hole-shaped portion 23 defined by peripheral surface portions 23f, 23r on the front and back sides on a deeper side, through which the large-diameter cylindrical portion 32 can slide in the X1 or X2 direction and go out or come in. The peripheral surface portions 21f, 21r on the front and back sides on the entry side, peripheral surface portions 22f, 22r on the front and back sides on the intermediate side, and peripheral surface portions 23f, 23r on the front and back sides on a deeper side are located different X-directional extension ranges Xb, Xc, Xd, Xe, Xg, and Xh, respectively.

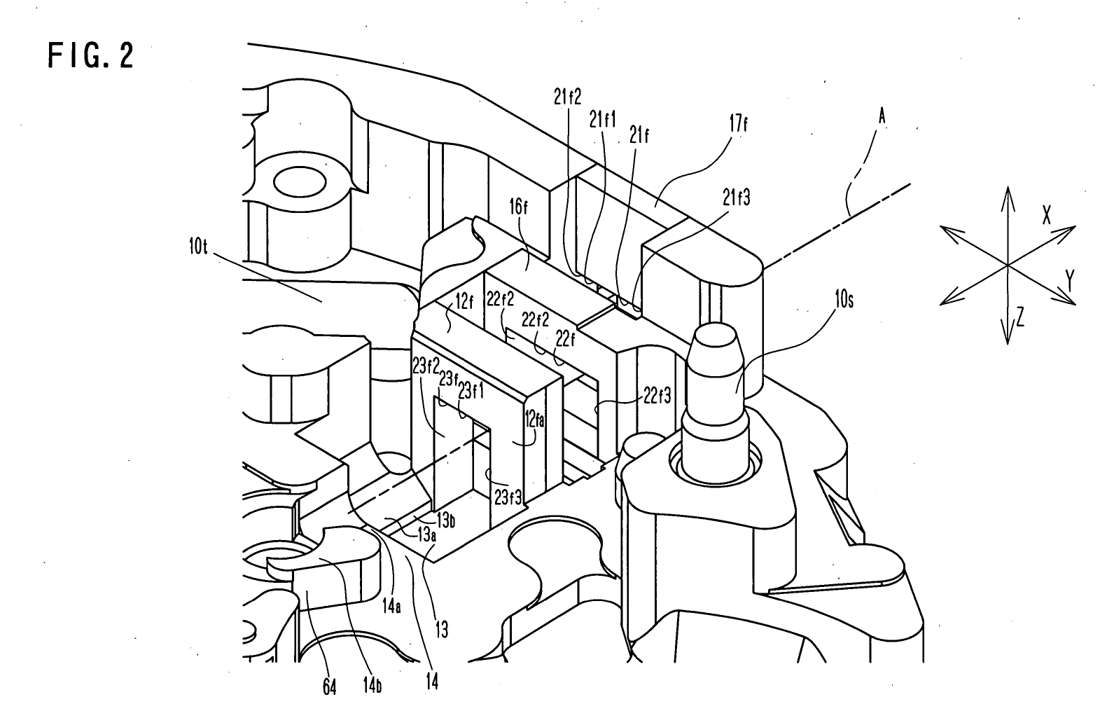

As can be seen from the cross-sectional view of FIG. 1B and the perspective view of FIG. 2, the front-side peripheral surface portion 21f includes planar side planes 21f2 and 21f3 extending along a Z-X plane at a right angle to the front-side plane 21f1, in addition to a planar front-side plane 21f1 extending along a X-Y plane. Therefore, the circular jaw portion 38 of the winding stem 30 circumscribes a cylindrical plane of a square defined by four planes 21f1, 21f2, 21f3, and 21r at the outer peripheral surface and slidably supported by the four planes 21f1, 21f2, 21f3, and 21r in the X1 and X2 directions.

In other words, in this example, the four planes 21f1, 21f2, 21f3, and 21r together define a square that circumscribes a circle made by the cross section of the circular jaw portion 38, when viewed (projected) in the X direction. However, the front-side plane 21f and the back-side plane 21r can define a polygon, a circle or other closed curves that circumscribe the circle of the circular jaw portion 38. Each of the front-side plane 21f and the back-side plane 21r may be of a different shape if the front-side plane 21f extends in the Z2 direction or is of the same shape or the back-side plane 21r extends in the Z1 direction or is of the same shape.

In addition, the side plane portions 21f2 and 21f3, in this example, extend along the range Xa since the side plane portions 21f2 and 21f3 together constitute part of the front-side plane portion 21f. However, the side plane portions 21f2 and 21f3 may extend within part of the range Xa.

Note that one or both or part of the side plane portion 21f2 and 21f3 may constitute part of the back-side plane portion 21r instead of the front-side plane portion 21f1. If this happens, the whole or part of side plane portion 21f2 and 21f3 extend in the X direction in the range Xb, but extends in the X direction in the same range as the back-side plane portion 21r or part of the range.

Similarly, the front-side peripheral surface portion 22f on the intermediate side includes planar side plane portions 22f2 and 22f3 extending along a Z-X plane at a right angle to the front-side plane portion 22f1, in addition to a planar front-side plane 22f1 extending along a X-Y plane. Therefore, the shaft portion 34a of the large-diameter shaft portion 34 on the base end side of the winding stem 30 circumscribes a cylindrical plane of a square defined by four planes 22f1, 22f2, 22f3, and 22r at the outer peripheral surface and slidably supported by the four planes. Therefore, the circular jaw portion 38 of the winding stem 30 circumscribes a cylindrical plane of a square defined by four planes 22f1, 22f2, 22f3, and 22r at the outer peripheral surface and slidably supported by the four planes 22f1, 22f2, 22f3, and 22r in the X1 and X2 directions. Note that the above description and changeability about the planes 21f and 21r is completely true of the planes 22f and 22r.

In addition, the front-side peripheral surface portion 23f on the deeper side includes planar side plane portions 23f2 and 23f3 extending along a Z-X plane at a right angle to the front-side plane portion 23f1, in addition to a planar front-side plane 23f1 extending along a X-Y plane. The large-diameter cylindrical portion 32 of the winding stem 30 circumscribes a cylindrical plane of a square defined by four planes 23f1, 23f2, 23f3, and 23r at the outer peripheral surface and slidably supported by the four planes 23f1, 23f2, 23f3, and 23r in the X1 and X2 directions. The above description and changeability about the planes 21f and 21r is also completely true of the planes 23f and 23r.

The hole portions 21 on the entry side is open on one side 111a of the external surface 11 of the bottom board 10. A hole portions 23 located deeper is open on deeper side surfaces 12fa and 12ra of the walls 12f and 12r of the bottom board 110 providing surfaces 23f and 23r defining the hole portions 23. Note that the bottom board 10 has a recess 13 for housing a clutch wheel in a position along the deeper side surface 12fa of the wall 12f, which recess extends from the front side of the bottom board 10 to the back side in a thickness direction Z. As can be seen from FIG. 2, the bottom 13a of the recess 13 for housing a clutch wheel is semi-cylindrical (the cross section is nearly semicircular) has a opening 13b in the middle.

The bottom board 10 also has a wall 14 behind the recess 13 for housing a clutch wheel, from which the rectangular column portion 31 located at the tip of the winding stem 30 can protrude in the X2 direction along a surface 14a. The bottom board 10 also has a spring housing hole portion 15 at small-diameter portions 36a and 36b on both sides of the abacus-bead-shaped portion 33 of the winding stem 30. For the spring housing hole portion 15, rough X-directional ranges Xe, Xf, and Xg are defined by the side surfaces 16fa and 12fb of walls 16f and 12f having surfaces 22f and 23f, respectively. In addition, these ranges are defined as a X-directional region or range Xf by the side surfaces 16ra and 12rb of walls 16r and 12r having surfaces 22r and 23r, respectively.

Note that in FIG. 2, a reference numeral 10s refers to a pin portion for positioning fixing the bottom board 10 on the train wheel bridge 2 by means of thermal coaking. A reference numeral 10t refers to a area where a quartz-crystal can (not shown) constituting an oscillator is arranged.

For the winding stem insertion aperture 20 in the above confirmation, the surfaces 21f and 21r of the hole portions 21 located in the X-directional region or ranges Xb and Xc are defined by the walls 17f and 17r of the bottom board 10. As can be seen from FIG. 1B and the like, the bottom board 10 further has a wall 18r on the back side Z2 of the winding stem 30 on the X1 side of the X-directional region or range Xb.

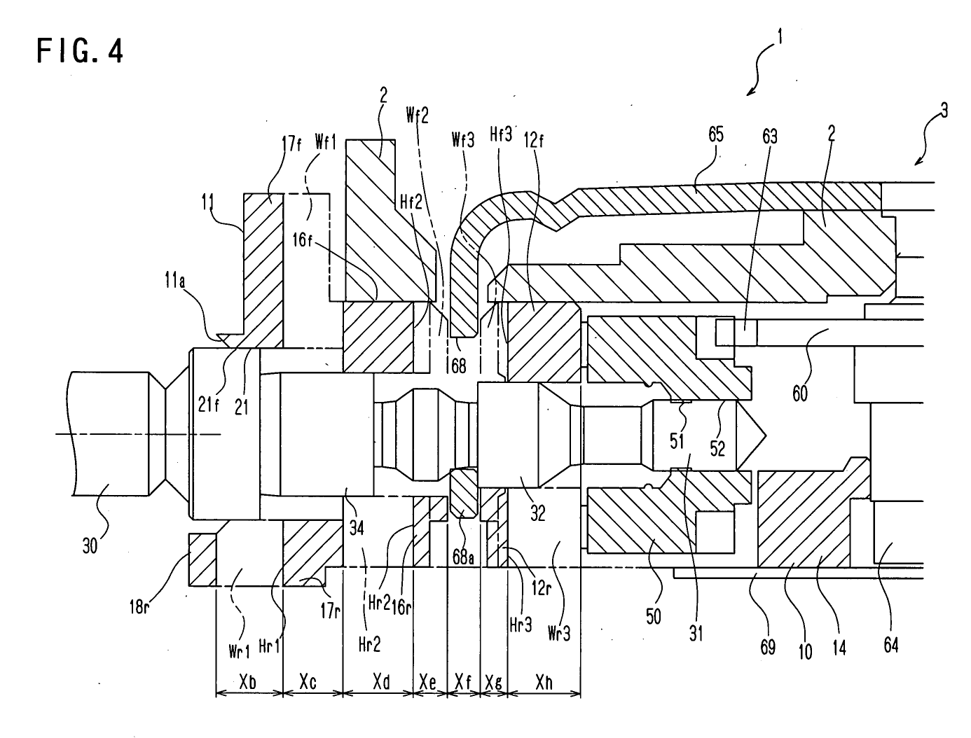

The bottom board 10 defined as described above is different from the bottom board 110 of the conventional electronic timepiece 101 shown in FIG. 5, as shown in FIG. 4. In FIG. 4, the portion of the wall that the bottom board 110 has but the bottom board 10 does not have (the portion of the wall that the bottom board 10 lacks) is indicated by the imaginary line. The portion of the wall that the bottom board 110 does not have but the bottom board 10 has is indicated by the broken line.

In other words, the bottom board 10, unlike the bottom board 110, lacks the back-side wall Wr1 in the region Xb where the wall 17f exists, which region is indicated as a void space or a gap Hr1. The bottom board 10, unlike the bottom board 110, also lacks the back-side wall Wr2 in the region Xd where the wall 16f exists, which region is indicated as a void space or a gap Hr2. The bottom board 10, unlike the bottom board 110, further lacks the back-side wall Wr3 in the region Xh where the wall 12f exists, which region is indicated as a void space or a gap Hr3.

In addition, the bottom board 10, unlike the bottom board 110, also lacks the back-side wall Wr1 in the region Xc where the wall 17r exists, which region is indicated as a void space or a gap Hfl. The bottom board 10, unlike the bottom board 110, also lacks the back-side walls Wf2 and Wf3 in the regions Xe and Xg where the walls 16r and 12r exist, which region is indicated as void spaces or gaps Hf2 and Hf3.

In the above configuration, the walls 17f, 16f, and 12f together constitutes one set of hole provision walls while the walls 17r, 16r, and 12r together constitutes the other set of hole provision walls.

Note that the bottom board 10 is slightly different from the bottom board 110 in shape of the back-side walls in the regions Xe and Xg and the like in order to secure the strength of and maintain the shape of the walls 16r and 12r of the bottom board 10, for example. In some cases, however, the bottom board 10 may have the same shape and the like of the portion of interest as the bottom board 110.

A clutch wheel 50 is arranged in the recess 13 for housing a clutch wheel. The clutch wheel 50 has a intermediate-diameter rectangular column hole portion 51 with a cross-section shape complementary to the rectangular column portion 31 of the winding stem 30. The clutch wheel 50 also has a intermediate-diameter cylindrical hole portions 52, which is located on the tip side of the cylindrical hole portions 51 and shaped to circumscribe the rectangular column portion 31. In addition, the clutch wheel 50 has a large-diameter cylindrical hole portions 53 on the base end portion side and a gear portion 54 located deeper. When the winding stem 30 is set in a hand-turning position P1 drawn out in the X1 direction as shown in FIG. 3, the cylindrical hole portions 51 of the clutch wheel 50 is just fit into the rectangular column portion 31 of the winding stem 30. The clutch wheel 50 then turns in response to the turning of the winding stem 30 around the central axis A. Meanwhile, if the winding stem 30 is pushed in the X2 direction into a usual hand-moving position P0 as shown in FIG. 1B, the cylindrical hole portions 51 of the clutch wheel 50 is loosely fit into the small-diameter shaft portion 37. The cylindrical hole portions 52 then circumscribes the rectangular column portion 31 of the winding stem 30, thus fitting the clutch wheel 50 into the winding stem 30. The clutch wheel 50 is therefore rotatable around the central axis A with respect to the winding stem 30.

The gear portion 54 of the clutch wheel 50 is engaged with a gear portion 63 of a minute wheel 60 rotatably supported by shaft portion 61 and 62 through the bearing portion 14b of the wall 14 of the bottom board 10 and the bearing portion 2a of the train wheel bridge 2. The gear portion 63 of the minute wheel 60 is engaged with a cannon pinion portion of a minute wheel not shown. A cannon pinion portion 64 protruding in the Z2 direction to the back side of the bottom board 10 is engaged with the gear portion of a cylindrical wheel (hour wheel) not shown.

A spring portion 66, which constitutes part of an positive battery terminal 65 supported by the train wheel bridge 2, is engaged with the small-diameter portion 36b or 36a of the winding stem 30 at an opening 68 by a bent end portion 67. More specifically, in this example, the spring portion 66 uses a back-sidewall 68a that forms the opening 68 and gives the winding stem 30 an elastic biasing force that will pull up the engagement portion of the winding stem 30 in the Z1 direction. When the winding stem 30 is moved in and out in the X1 and X2 directions, the spring portion 66 permits the winding stem 30 to move in and out in the X1 and X2 directions while elastically pulling up and biasing the abacus-bead-shaped portion 33 in the Z1 direction. The spring portion 66 is then elastically fit into the other small-diameter portion 36a or 36b. In this way, a feel of click is produced and the winding stem 30 is held in a stable way in the position of interest. Note that a reference numeral 69 is a cylindrical-wheel retainer.

In the electronic timepiece 1 configured as described above, the bottom board 10, unlike the conventional bottom board 110, lacks walls in the recesses Hr1, Hr2, Hr3, Hf1, and Hf2 in the periphery of the winding stem insertion aperture 20.

However, the winding stem 30 is guided in the X1 and X2 direction in the bottom board 10 as in the bottom board 110.

In other words, if the winding stem 30 is in the usual hand-moving position P0 as shown in FIG. 1B, the jaw portion 38 is supported by the walls 17f and 17r and the cylindrical portion 34a is supported by the walls 16f and 16r. The cylindrical portion 32 is supported by the wall 12f and the rectangular column portion 31 is supported by the wall 14. The bottom board 10 can therefore support the winding stem 30 in a stable way. With the winding stem 30 in the position P0, the spring portion 66 pulls up the circular jaw portion 38 and cylindrical portions 34a and 32 in the Z1 direction. This gives the winding stem 30 a biasing force or causes these portions to be pressed against the wall surfaces 21f, 22f, and 23f of the walls 17f, 16f, and 12f. Thus, the winding stem 30 can be supported by the walls 17f, 16f and 12f in a stable way.

Meanwhile, if the winding stem 30 is in the hand-turning position P1 as shown in FIG. 3, the jaw portion 38 is supported by the wall 17f and the cylindrical portion 34a is supported by the walls 16f. The cylindrical portion 32 is supported by the walls 12f and 12r. Note that even with the winding stem 30 in the position 1, the spring portion 66 slightly pulls up the winding stem 30 in the Z1 direction and presses the jaw portion 38 and the cylindrical portions 34a and 32 against the wall surfaces 21f, 22f, and 23f of the walls 17f, 16f, and 12f. Thus, the winding stem 30 can be supported by the walls 17f, 16f, and 12f in a stable way.

If, in addition, the winding stem 30 is pulled out of the usual hand-moving position P0 into the hand-turning position P1 in the X1 direction, the wall 17r stops supporting the jaw portion 38 and the wall 16r stops supporting the cylindrical portion 34a at some time while the winding stem 30 is being pulled out. However, the wall 12r then starts supporting the cylindrical portion 32 and the winding stem 30 can be supported by the bottom board 10 in a stable way. Note that a range over which the front and back walls 17f, 17r, 16f, 16r, 12f, and 12r extend in the X direction is set to prevent the loss of support by all of the back-side walls 17r, 16r, and 12r while the winding stem 30 is pulled out in the X1 direction. If desired, the front- and back-side walls 17f, 17r, 16f, 16r, 12f, and 12r may be further divided for force distribution over the front and back to prevent the imbalanced support of the winding stem 30 when in the position P0 or P1 or otherwise. When, for example, the winding stem 30 is in the hand-turning position P1, the wall surface 18ra of the wall 18r (refer to FIG. 3) may be set so that the cylindrical jaw portion 38 may be supported by the wall 18r.

Note that even if the winding stem 30 is displaced from the position P0 to the position P1 as described above, the spring portion 66 pulls up the winding stem 30 in the Z1 direction and presses the jaw portion 38 and the cylindrical portions 34a and 32 against the wall surfaces 21f, 22f, and 23f of the walls 17f, 16f, and 12f. Thus, the winding stem 30 can be supported by the walls 17f, 16f, and 12f in a stable way. Particularly if the winding stem 30 is displaced from the position P0 to the position P1, the abacus-bead-shaped portion 33 passes by the opening 68 by the spring portion 66. The wall 68a that is associated with the opening 68 then exerts a stronger biasing force on the winding stem 30 in the Z1 direction. This cause the portions 38, 34a, and 32 of the winding stem 30 to be pressed against the wall surfaces 21f, 22f, and 23f of the walls 17f, 16f, and 12f with a stronger force. Thus, the winding stem 30 can be supported in a stable way.

Even when the winding stem 30 is pushed from the hand-turning position P1 into the usual hand-moving position P0, the front and back walls 17f, 17r, 16f, 16r, 12f, and 12r similarly support the winding stem 30. The spring portion 66 then presses the winding stem 30 against the wall surfaces 21f, 22f, and 23f of the walls 17f, 16f, and 12f. Thus, the winding stem 30 is supported in a stable way.

In the electronic timepiece 1, the winding stem insertion aperture 20 is a through hole since the minute wheel is engaged directly with the clutch wheel. However, the void space for winding stem insertion may take the form of a bottom hole having a wall at a deeper end portion, as shown in Patent Documents 1 and 2.

A mold structure and method for forming a bottom board 10 for the electronic timepiece 1 configured as described above, according to a preferred embodiment of the present invention, will be described below with reference to FIG. 1A.

A mold structure 5 according to the present invention is composed of a lower mold 70 and an upper mold 80. Note that FIG. 1A shows only those portions of the molds that are related to the portion between wall 12f and the wall 18r of the bottom board 10 shown in FIG. 1B.

The lower mold 70 is left at rest on and fixed to the base (not shown). The upper mold 80 is movable in a vertical direction Z with respect to the lower mold 70. Needless to say, the upper mold 80 may be fixed and the lower mold 70 may be movable in the Z direction or both of the lower mold 70 and the upper mold 80 may be movable in the Z direction. The mold is movable typically in the vertical direction. The mold may be relatively movable in an oblique or horizontal direction. In any case, a pair of molds 70 and 80 are moved closer to and away from each other in the Z direction as shown in FIG. 1B and the like.

In this example, the lower mold 70 has a bottom wall portion 72 on the bottom surface 71. The lower mold 70 also has parallel protrusions 74, 75, and 76 of different height, which protrude from the Z1-side surface 73 of the bottom wall portion 72 in the Z1 direction and a small protrusion 77 that protrudes in the Z1 direction between the protrusions 75 and 76. The protrusions 74, 75, 77, and 76 have widths Xb, Xd, Xf, and Xh, respectively. Gaps 78c, 78e, and 78g having sizes Xc, Xe, and Xg are formed between the protrusions 74, 75, and 77 and adjacent protrusions 75, 77, and 76, respectively. A surface 73 of the lower mold 70 has surface portions 73c, 73e, and 73g at different heights at the gaps 78c, 78e, and 78e, respectively. The surface portion 73c is further composed of surface portions 73c1 and 73c2 of different height. The surface portion 73e is also compose of surface portions 73e1 and 73e2 of different height. The surface portion 73g is also compose of surface portions 73g1 and 73g2 of different height. The protrusion 74 has an end surface 73f composed of an inclined top surface portion 74f1 and a flat top surface portion 74f2. The protrusions 75, 76, and 77 have flat top surface portions 75f, 76f, and 77f, respectively Meanwhile, the upper mold 80 has a top wall 82 under a top surface 81. The upper mold 80 also has parallel protrusions, 84, 85, 86, and 87 of different height, which protrude from the Z2-side surface 83 of the top wall 82 in the Z2 direction. The protrusions 85 and 86 have a width Xc and width (Xe+Xf+Xg), respectively. Gaps 88b and 88d having sizes Xb and Xd are formed between protrusions 84 and 85 and adjacent protrusions 85 and 86, respectively. There is also a recess 88h having a width Xh on the X2 side of the protrusion 86. A surface 83 of the upper mold 80 has surface portions 83b, 83d, and 83h at different heights at the gaps 88b and 88d and the recess 88h, respectively. The surface portion 83b is further composed of surface portions 83b1 and 83b2 of different height. The protrusions 84 and 85 have flat bottom surface portions 84r and 85r, respectively. The protrusion 86 has bottom surface portions 86r1 and 86r2 of different height. The bottom surface portion 86r1 has a width-Xe and the bottom surface portions 86r2 has a width (Xf+Xg).

The bottom board 10 is formed as described below using the mold structure 5 having the lower mold 70 and the upper mold 80, which is configured as described above.

The upper mold 80 is initially at a mold-separating position Q1 located upward in the Z1 direction with respect to the lower mold 70 in the formed of a fixed mold, as shown by the imaginary line in FIG. 1A. At the mold-separating position Q1, all of the protrusions 84, 85, 87, and 87 on the upper mold 80 is completely separate from the corresponding recesses 78a, 78c, and 78j as well as the portion 78eg (recesses 78e and 78g) between the protrusions 75 and 76 on the lower mold 70. The protrusions 74, 75, and 76 on the lower mold 70 are completely separate from the corresponding recesses 88b, 88d, and 88h on the upper mold 80.

During a forming process, the upper mold 80 is pushed down to the mold-clamping position Q2 indicated by the solid line in the Z2 direction. With the translation and lowering of the upper mold 80 in the Z2 direction, the end portions 84a, 85a, 87a, and 86a of the protrusions 84, 85, 87, and 86 on the upper mold 80 are just fit into the corresponding recesses 78a, 78c, 78j, and 78eg (78e and 78g) on the lower mold 70. The end portions 74a, 75a, and 76a of the protrusions 74, 75, and 76 on the lower mold 70 are then just fit into the corresponding recesses 88b, 88d, and 88h on the upper mold 80. The end surface 86r2 of the protrusion 86 on the upper mold 80 then comes into contact with the end surface 77f of the protrusion 77 on the lower mold 70. The upper end of the inclined end surface 74f1 of the protrusion 74 on the lower mold 70 then comes into contact with the protruding bottom surface portion 83b1 of the recess 88b in the upper mold 80. The upper mold 80 then stops lowering in the Z2 direction, thus completing the mold clamping process.

With the molds clamped as described above, the end portions 84a, 74a, 85a, 75a, 86a, 76a, and 87a of the upper mold 80 and lower mold 70 of the mold structure S are arranged continuously in the X direction, thus forming recesses 91r, 92f, 92r, 93f, 93r, 94r, and 94f deeper than these end portions. Under the above-mentioned condition, a series of end portions arranged in a row in the X direction, 84a, 74a, 85a, 75a, 86a, 76a, and 87a, together serve as a shaft-shaped void space formation portion and occupy a region corresponding to the winding stem insertion aperture 20, which is a shaft-shaped void space or horizontal hole. A void space 91r is formed by the surface 73a of the recess 78a in the lower mold 70, a side surface of the protrusion 74 on the lower mold 70, and the end surface 84r of the protrusion 84 in the upper mold 80. The void space 91r has a shape complementary to the shape of the wall 18r of the bottom board 10. Avoid space 92f is formed by a side surfaces of the protrusions 84 and 85 in the upper mold 80, the surface 83b of the recess 88b on the upper mold 80, and the end surface 74f of the protrusion 74 on the lower mold 70. The 92f has a shape complementary to the shape of the wall 17f of the bottom board 10. A void space 92r is formed by the side surfaces of the protrusions 74 and 75 on the lower mold 70, the surface 73c of the recess 78c in the lower mold 70, and the end surface 85r of the protrusion 85 in the upper mold 80. The void space 92r has a shape complementary to the shape of the wall 17r of the bottom board 10. A void space 93f is formed by the side surfaces of the protrusions 85 and 86 in the upper mold 80, the surface 83d of the recess 88d on the upper mold 80, and the end surface 75f of the protrusion 75 on the lower mold 70. The 93f has a shape complementary to the shape of the wall 16f of the bottom board 10. A void space 93r is formed by the side surfaces of the protrusions 75 and 77 on the lower mold 70, the surface 73e of the recess 78e in the lower mold 70, and the end surface portion 86r1 of the protrusion 86 in the upper mold 80. The void space 93r has a shape complementary to the shape of the wall 16r of the bottom board 10. A void space 94r is formed by the side surfaces of the protrusions 77 and 76 on the lower mold 70, the surface 73g of the recess 78g in the lower mold 70, and the end surface portion 86r2 of the protrusion 86 in the upper mold 80. The void space 94r has a shape complementary to the shape of the wall 12r of the bottom board 10. A void space 94f is formed by the side surfaces of the protrusions 86 and 87 in the upper mold 80, the surface 83h of the recess 88h on the upper mold 80, and the end surface 76f of the protrusion 76 on the lower mold 70. The 94f has a shape complementary to the shape of the wall 12f of the bottom board 10.

When the upper mold 80 reaches the mold-clamping position Q2 and the mold clamping process is terminated, molding resin material is introduced from a molding material introduction hole (not shown). The material is introduced to and fills the recesses 91r, 92f, 92r, 93f, 93r, 94r and 94f, thus completing the formation of the bottom board 10.

After the solidification or hardening of the molding resin material, the upper mold 80 is pulled up in the Z1 direction, thus starting mold opening. The upper mold 80 is returned to a mold-opening position Q1 and the bottom board 10 formed is removed from the mold. Typically, the upper and lower molds 80, 70 are so configured as to cause the bottom board 10 to be lifted up in the Z1 direction together with the upper mold 80 when the molds are opened before being pushed with a pin and the like to separate the bottom board 10 from the mold 80. If desired, however, these molds may be so configured as to cause the bottom board 10 formed to be left together with the lower mold 70 at the time of mold opening. In the above case, these molds may be so configured as to cause the bottom board 10 to be pushed up with a pin and the like in the Z1 direction and separated from the lower mold 70 after the upper mold 80 is opened in the Z2 direction. The bottom board 10 formed has walls 18r, 17f, 17r, 16f, 16r, 12r, and 12f, which correspond to the recesses 91r, 92f, 92r, 93f, 93r, 94r, and 94f in terms of shape.

The mold structure 5 does not require a hydraulic core for forming a winding stem 30 insertion aperture 20 in the bottom board 10. This allows a reduction in complexity of the construction of the mold structure 5 itself and the construction of an opening/closing control mechanism for mold structure 5. Therefore, costs required can be reduced. After all, the total cost required for the manufacture of a bottom board 10 can be reduced. In addition, the mold structure 5 according to the invention has an simpler construction and does not require an elongated hydraulic core for forming the winding stem insertion aperture 20. Therefore, the mold structure 5 is less likely to be damaged, thus making it possible for the mold structure 5 to form highly accurate bottom boards 10 for a long time.

Note that the mold structure 5 typically has no hydraulic cores. If desired, however, a hydraulic core not shown may be used to form a horizontal hole other than the winding stem insertion aperture (or hole).

What is claimed is:

1. A method for forming a timepiece train wheel support plate comprising the steps of:
moving a pair of molds having a plurality of protrusions closer to an opposite surface;
fitting end portions of the plurality of protrusions on one of the pair of molds among end portions of a plurality of protrusions on the other mold; and
filling a void space formed by the pair of molds with molding material to form a timepiece train wheel support plate having a horizontal hole corresponding to a series of the end portions of the plurality of protrusions on the pair of molds, the series of the end portions being fit to one another.

2. A mold structure for forming a timepiece train wheel support plate by the method according to claim 1.

3. A mold structure for forming a timepiece train wheel support plate comprising:
first and second molds relatively movable between a mold-clamping position and a mold-separating position, said first mold comprising a plurality of protrusions having an end portion extending parallel from a surface facing the second mold toward the second mold and said second mold comprising a plurality of protrusions having an end portion extending parallel from a surface facing the first mold toward the first mold and, when set in the mold-clamping position, fit among end portions of adjacent protrusions of the plurality of protrusions on the first mold;
in the mold-clamping position, the end portions of the plurality of protrusions of the first and second molds, being fit to one another, defines a shaft-like void space formation portion extending continuously in a direction intersectional to a direction in which the end portions extend.

4. A mold structure according to claim 3, wherein at least one of the plurality of protrusions on one of the first and second molds has a different height from a height of the other protrusions.

5. A mold structure according to claim 3, wherein the plurality of protrusions on one of the first and second molds, the surface of a recess between at least a set of adjacent protrusions has a different height from a height of the surface of a recess between other sets of adjacent protrusions.

6. A mold structure according to claim 3, wherein the plurality of protrusions on one of the first and second molds, the surface of a recess between at least a set of adjacent protrusions has a surface portion with a different height.

7. A mold structure according to claim 3, wherein one of the first and second molds has a small protrusion that comes into contact with the middle of an end face of an end portion of one of the plurality of protrusions on the other mold.

8. A mold structure according to claim 5, wherein the protrusions on the first and second molds extend vertically with respect to a timepiece train wheel support plate to be formed.

9. A mold structure according to claim 5, wherein a void space formed by the shaft-like void space formation portion is a winding stem insertion aperture.

10. A timepiece train wheel support plate open on a side thereof and having a slotted hole extending in a direction in which the plate extends from the side comprising:
a first set of a plurality of hole provision walls spaced in a longitudinal direction of the hole on one side in a thickness direction of the plate to define the slotted hole; and
a second set of a plurality of hole provision walls spaced in a longitudinal direction of the hole on the other side of the plate on the other side in a thickness direction of the hole;
wherein on the one side in the thickness direction of the plate, portions facing the second set of individual hole provision walls in a thickness direction are a first gap between the first set of hole provision walls; and
wherein on the other side in the thickness direction of the plate, portions facing the first set of individual hole provision walls in a thickness direction are a second gap between the second set of hole provision walls.

11. A timepiece train wheel support plate according to claim 10, wherein on the one side in the thickness direction of the plate, portions facing the second sets with respect to at least a portion of gaps are gaps between the first set of hole provision walls.

12. A timepiece comprising a timepiece train wheel support plate according to claim 10.
